(19) United States
(12) Patent Application Publication
(10) Pub. No.: US 2025/0279219 A1
(43) Pub. Date: Sep. 4, 2025

(54) Wire

(71) Applicants: Tyco Electronics Technology (SIP) Co., Ltd., Suzhou (CN); Tyco Electronics (Shanghai) Co., Ltd., Shanghai (CN)

(72) Inventors: Ping Wu, Shanghai (CN); Xize Cao, Shanghai (CN); Wei He, Shanghai (CN); Yanjun (Leo) Sha, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 19/066,513

(22) Filed: Feb. 28, 2025

(30) Foreign Application Priority Data
Mar. 1, 2024 (CN) 202410238915.X

(51) Int. Cl. H01B 1/02; H01B 7/00; H01B 7/02

(52) U.S. Cl. CPC H01B 1/02; H01B 7/0009; H01B 7/0241

(57) ABSTRACT

A wire includes a steel wire conductor and an insulation layer wrapped around the steel wire conductor. The steel wire conductor has a steel wire and a copper layer wrapped around the steel wire. The steel wire of the steel wire conductor has high strength and flexibility, and the copper layer of the steel wire conductor has high conductivity and current carrying capacity.

### CROSS-REFERENCE TO RELATED APPLICATION

This application claims the benefit of the filing date under 35 U.S.C. § 119(a)-(d) of Chinese Patent Application No. 202410238915.X, filed on Mar. 1, 2024.

### FIELD OF THE INVENTION

The present invention relates to a steel wire conductor for a wire and a wire comprising the steel wire conductor.

### BACKGROUND OF THE INVENTION

Small and lightweight automotive wiring harness products are one of the development directions of automotive technology. Small and lightweight wires can not only reduce costs but also lower the overall weight of the vehicle and reduce energy consumption. Therefore, finer, and lighter automotive wiring harnesses are the future development trend.

At present, the signal wires of automotive wiring harnesses generally use soft copper wires with a cross-sectional area of 0.35 mm² or 0.5 mm². The signal wire current is small and the wire utilization rate is low, but the strength of soft copper is weak. If the cross-sectional area of the signal wire is reduced, it will result in the signal wire strength not meeting the application requirements.

In order to reduce the size of signal wires, copper alloy wires with a cross-sectional area of 0.13 mm² are used instead of soft copper wires with a cross-sectional area of 0.35 mm² or 0.5 mm². Copper alloy wires have high strength but poor flexibility and are prone to breakage during assembly and application.

### SUMMARY OF THE INVENTION

A wire includes a steel wire conductor and an insulation layer wrapped around the steel wire conductor. The steel wire conductor has a steel wire and a copper layer wrapped around the steel wire.

### BRIEF DESCRIPTION OF THE DRAWINGS

The invention will now be described by way of example with reference to the accompanying figures, of which:

FIG. 1 shows an illustrative view of a wire according to a first embodiment of the present invention;

FIG. 2 shows a cross-sectional view of the wire according to the first embodiment of the present invention;

FIG. 3 shows an illustrative perspective view of a steel wire conductor for a wire according to the first embodiment of the present invention;

FIG. 4 shows an illustrative view of a wire according to a second embodiment of the present invention;

FIG. 5 shows a cross-sectional view of the wire according to the second embodiment of the present invention; and

FIG. 6 shows an illustrative perspective view of a steel wire conductor for a wire according to the second embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

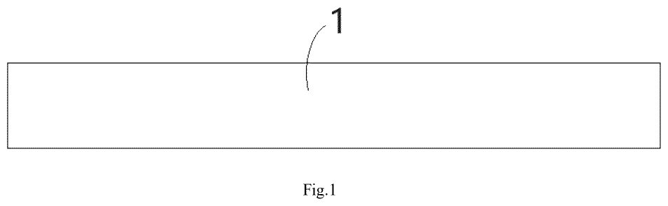

FIGS. 1 to 3 show a first embodiment according to the present invention. As shown in FIGS. 1 to 3, in an exemplary embodiment of the present invention, a wire 1 is disclosed. The wire 1 includes a steel wire conductor 10 and an insulation layer 14. The steel wire conductor 10 is wrapped in the insulation layer 14. The steel wire conductor 10 includes a steel wire 11 and a copper layer 12. The copper layer 12 is wrapped around an outside of steel wire 11.

In the embodiment of FIGS. 1-3, the steel wire 11 of the steel wire conductor 10 has high strength and flexibility, and the copper layer 12 of the steel wire conductor 10 has high conductivity and current carrying capacity. Therefore, the present invention can reduce the size of wire 1 while ensuring its strength, flexibility, conductivity, and current carrying capacity.

As shown in FIGS. 1 to 3, in the illustrated embodiment, the wire 1 comprises multiple steel wire conductors 10, and any two adjacent steel wire conductors 10 among the multiple steel wire conductors 10 are tangent to each other. In the illustrated embodiment, one of the multiple steel wire conductors 10 is located at the center of the wire 1, and other steel wire conductors 10 except for the one located at the center of the wire are arranged around the one located at the center of the wire 1.

As shown in FIGS. 1 to 3, in the illustrated embodiment, multiple steel wire conductors 10 in the wire 1 have the same diameter as each other and are twisted together. The present invention is not limited to the illustrated embodiment. For example, in another exemplary embodiment of the present invention, the diameter of other steel wire conductors 10 among the multiple steel wire conductors 10, except for the one located at the center of the wire 1, is different from the diameter of the one located at the center of the wire 1. In another exemplary embodiment of the present invention, the diameter of other steel wire conductors 10 among the multiple steel wire conductors 10, except for the one located at the center of the wire 1, is smaller than the diameter of the one located at the center of the wire 1. In another exemplary embodiment of the present invention, the diameters of other steel wire conductors 10 among the multiple steel wire conductors 10, except for the one located at the center of the wire 1, are the same as each other.

As shown in FIGS. 1 to 3, in the illustrated embodiment, the wire 1 comprises seven steel wire conductors 10, the diameters of the seven steel wire conductors 10 are the same as each other, and the diameters of the steel wires 11 of the seven steel wire conductors 10 are the same as each other. However, the present invention is not limited to the illustrated embodiments. For example, in another exemplary embodiment of the present invention, the wire 1 may include two, three, four, five, six, eight, or more steel wire conductors 10.

As shown in FIGS. 1 to 3, in the illustrated embodiment, the thickness of the copper layer 12 of the steel wire conductor 10 is less than 10% of the diameter of the steel wire 11 of the steel wire conductor 10 and greater than 1% of the diameter of the steel wire 11. For example, in the illustrated embodiment, the thickness of copper layer 12 may be 3-5 μm. However, the present invention is not limited to this, for example, the cross-section of the copper layer 12 of each steel wire conductor 10 may account for 40% of the total cross-section of each steel wire conductor 10.

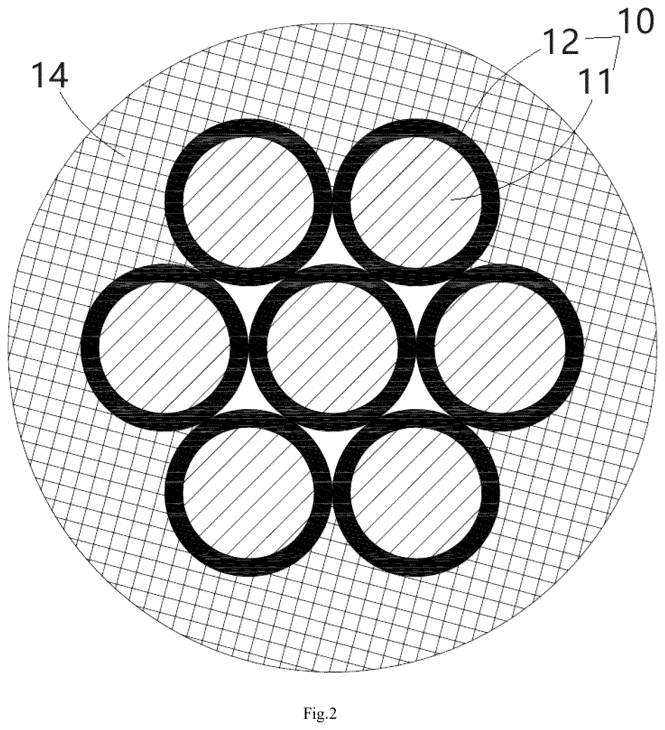

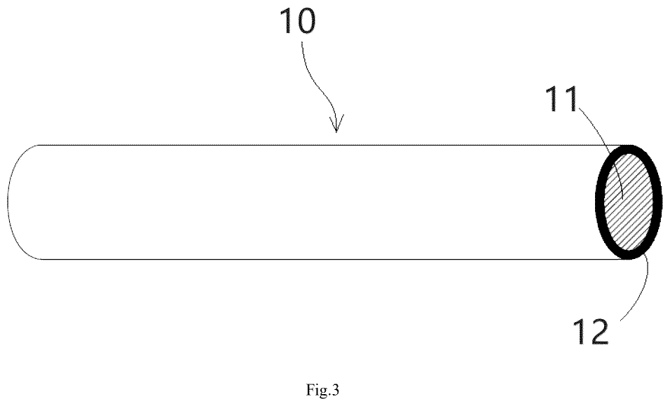

As shown in FIGS. 2 and 3, the steel wire conductor 10 includes a steel wire 11 and a copper layer 12. The copper layer 12 is wrapped around the outside of steel wire 11.

As shown in FIGS. 1 to 3, in the illustrated embodiment, the wire 1 includes seven steel wire conductors 10 with a diameter of 0.25 mm and an insulation layer 14 with a diameter of 1.2˜1.4 mm. The cross-sectional area of steel wire 11 in seven steel wire conductors 10 is approximately 0.35 mm², and the cross-sectional area of the copper layer 12 in seven steel wire conductors 10 is approximately 0.13 mm².

In the embodiment of FIGS. 1-3, the steel wire 11 in the steel wire conductor 10 serves as a strength reinforcement structure to enhance the strength of the wire 1, and the copper layer 12 in the steel wire conductor 10 serves as an excellent conductive medium, providing wire stable conductivity and reliable terminal crimping performance. The insulation layer 14 of the wire 1 can be made of insulation materials such as PVC, XLPE, or FEP according to different application environments.

As shown in FIGS. 1 to 3, in the illustrated embodiment, in order to achieve electrical connection between a terminal and the wire 1, the terminal is usually crimped onto one end of the wire 1. The terminal crimping area has a concave convex serrated structure. During the terminal crimping process, as the crimping height decreases, the deformation of the steel wire conductor 10 in the crimping area increases. Within a certain crimping height range, the crimping height decreases, and the larger the deformation of the steel wire, the greater the terminal crimping retention force. Therefore, the steel wire conductor 10 can increase the pressure retention force between the wire 1 and the terminal.

The steel wire conductor 10 plays a role in ensuring the strength of the wire structure. The elongation of steel wire 11 will decrease with increasing strength, while the hardness will increase. The steel wire 11 undergoes appropriate deformation during the terminal crimping process, providing reliable crimping retention force. Simultaneously select low-carbon steel material with a C content of 0.1%, which has excellent compressive and impact toughness. When choosing high carbon steel wire 11, it is prone to brittle fracture during the terminal crimping process.

After wire 1 according to the embodiment of FIGS. 1-3 is crimped at the terminal, the surface coating of wire 11 needs to form a stable and reliable frictional force with the terminal to prevent the wire 1 from easily withdrawing from the crimping area of the terminal, thereby ensuring that the terminal crimping retention force is greater than 50N. By comparing and verifying the different coatings (zinc, tin, copper) on the surface of steel wire 11, it was found that the copper layer on the surface of steel wire 11 exhibited the best crimping retention performance. Experimental verification shows that achieving a copper layer of 3˜5 μm on the surface of steel wire 11 can achieve good crimping retention.

As shown in FIG. 2, in the illustrated embodiment, after multiple steel wire conductors 10 are twisted in the wire 1, the surface of the steel wire conductors 10 is round and has a high degree of concentricity. Finally, the surface of wire 1 after extruding the outer insulation layer 14 is round and smooth.

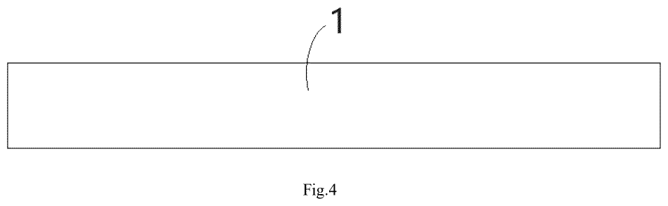

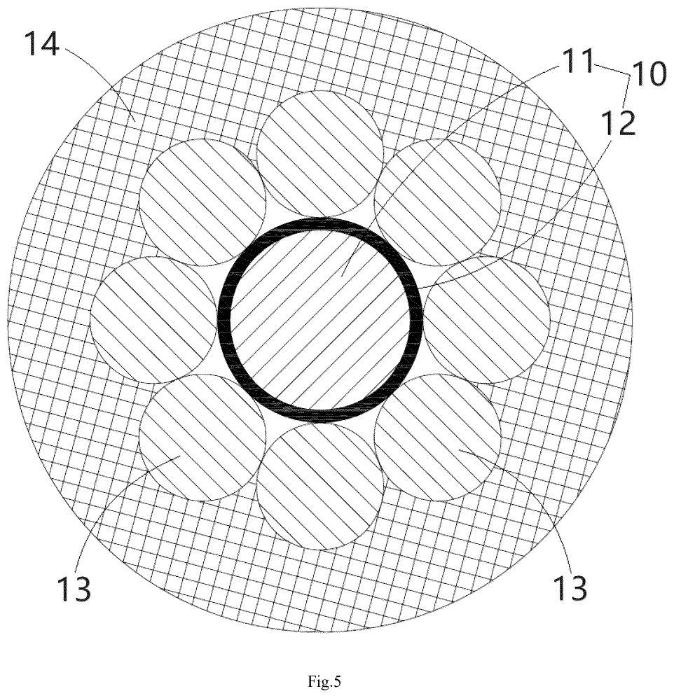

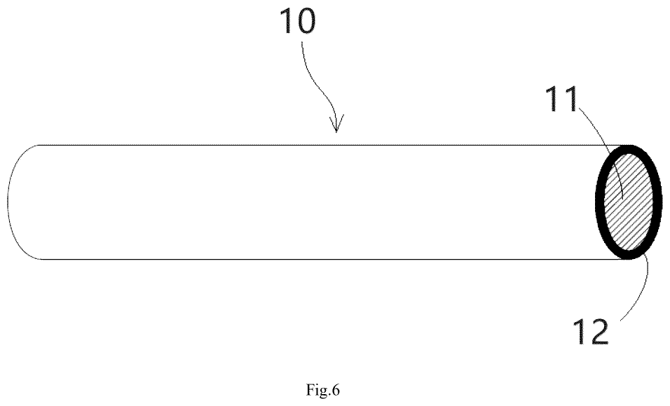

FIGS. 4 to 6 show a second embodiment according to the present invention. As shown in FIGS. 4 to 6, in an exemplary embodiment of the present invention, a wire 1 is disclosed. The wire 1 includes a single steel wire conductor 10, multiple copper wires 13, and an insulation layer 14. The single steel wire conductor 10 is located at the center of the wire 1. Multiple copper wires 13 are arranged around the single steel wire conductor 10. The single steel wire conductor 10 and multiple copper wires 13 are wrapped in the insulation layer 14.

In the embodiment of FIGS. 4 to 6, the steel wire 11 of the steel wire conductor 10 has high strength and flexibility, and the copper layer 12 of the steel wire conductor 10 has high conductivity and current carrying capacity. Therefore, the present invention can reduce the size of wire 1 while ensuring its strength, flexibility, conductivity, and current carrying capacity.

As shown in FIGS. 4 to 6, in the illustrated embodiment, multiple copper wires 13 are twisted onto the single steel wire conductor 10, such that multiple copper wires 13 are tangent to the single steel wire conductor 10 and any two adjacent copper wires 13 in the multiple copper wires 13 are tangent to each other.

As shown in FIGS. 4 to 6, in the illustrated embodiment, the diameter of the steel wire 11 in the single steel wire conductor 10 is larger than the diameter of the copper wire 13. In the illustrated embodiment, the wire 1 includes eight copper wires 13, whose diameters are the same as each other, and whose diameters are smaller than the diameter of the steel wire 11 in the single steel wire conductor 10. However, the present invention is not limited to the illustrated embodiments. For example, in another exemplary embodiment of the present invention, the wire 1 may include four, six, ten, or more copper wires 13.

The steel wire conductor 10 includes a steel wire 11 and a copper layer 12. The copper layer 12 is wrapped around the outside of steel wire 11. As shown in FIGS. 4 to 6, in the illustrated embodiment, the thickness of the copper layer 12 of the steel wire conductor 10 is less than 10% of the diameter of the steel wire 11 of the steel wire conductor 10 and greater than 1% of the diameter of the steel wire 11. For example, in the illustrated embodiment, the thickness of copper layer 12 may be 3˜5 μm.

As shown in FIGS. 4 to 6, in the illustrated embodiment, the wire 1 includes a steel wire conductor 10 with a diameter of 0.25 mm and eight copper wires 13 with a diameter of 0.15 mm. The cross-sectional area of the copper layer 12 of the steel wire conductor 10 and eight copper wires 13 is approximately 0.19 mm².

As shown in FIGS. 4 to 6, in the illustrated embodiment, when the steel wire conductor 10 and the copper wires 13 of wire 1 are twisted, the steel wire conductor 10 serves as a strength reinforcement structure located at the center of wire 1, and eight copper wires 13 are tightly twisted around the central steel wire conductor 10.

As shown in FIGS. 4 to 6, in the illustrated embodiment, the copper layer 12 of the steel wire conductor 10 serves as an excellent conductive medium, providing stable and reliable terminal crimping performance. The insulation layer 14 of wire 1 can be made of insulation materials such as PVC, XLPE, or FEP according to different application environments, and the outer diameter of insulation layer 14 can be 1.1˜1.2 mm.

In order to achieve electrical connection between a terminal and the wire 1 of FIGS. 4 to 6, the terminal is usually crimped onto one end of wire 1. The terminal crimping area has a concave convex serrated structure. As the crimping height decreases during the terminal crimping process, the deformation of the steel wire conductor 10 in the crimping area increases. Within a certain crimping height range, the crimping height decreases, and the larger the deformation of the steel wire, the greater the terminal crimping retention force.

In the embodiment of FIGS. 4 to 6, the steel wire conductor 10 plays a role in ensuring the strength of the wire structure. The diameter of steel wire conductor 10 can be 0.25 mm, and the strength of steel wire 11 is selected as 1200 Mpa, which is equivalent to a tensile force of 60N. In addition, the tensile force of eight copper wires 13 is 26N. The final design tensile force of wire 1 is 86N, which has a reliable design margin compared to the standard 50N.

The elongation of steel wire 11 decreases with increasing strength, while the hardness increases. The steel wire 11 with a strength of 1200 MPa can maintain better ductility and low hardness and undergo appropriate deformation during terminal crimping to provide reliable crimping retention force. At the same time, the steel wire 11 is made of low-carbon steel material with a C content of 0.1%, which has excellent compressive and impact toughness. When choosing high carbon steel wire with a strength exceeding 2000 Mpa for the steel wire 11, experimental verification shows that brittle fracture occurs during the terminal crimping process.

In the embodiment of FIGS. 4 to 6, after the wire 1 is crimped at the terminal, the surface coating of the steel wire 11 needs to form a stable and reliable frictional force with the terminal to prevent the wire 1 from easily being pulled out of the crimping area of the terminal, thereby ensuring that the terminal crimping retention force is greater than 50N. By comparing and verifying the different coatings (zinc, tin, copper) on the surface of steel wire 11, it was found that the copper layer 12 on the surface of steel wire 11 had the best crimping retention performance. The copper layer 12 on the surface of steel wire 11 deformed with the surrounding copper wires 13, resulting in a connection effect close to cold welding. Experimental verification shows that a copper layer 12 of 3˜5 μm on the surface of steel wire 11 can achieve good crimping retention.

As shown in FIGS. 4 to 6, in the illustrated embodiment, the outer diameter of the steel wire conductor 10 wrapped with a copper layer 12 can be 0.25 mm, and the outer diameter of the copper wire 13 can be 0.15 mm. The size design of steel wire conductor 10 and copper wire 13 adopts characteristic twisting parameters and processes to ensure that the copper wire 13 completely covers the central steel wire conductor 10 after twisting. The surface of multiple copper wires 13 after twisting is round and has extremely high concentricity. Finally, the surface of wire 1 after extruding the outer insulation layer 14 is round and smooth.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A wire, comprising:
a steel wire conductor including a steel wire and a copper layer wrapped around the steel wire; and
an insulation layer wrapped around the steel wire conductor.

2. The wire according to claim 1, wherein the steel wire conductor is one of a plurality of steel wire conductors, any two adjacent steel wire conductors of the plurality of steel wire conductors are tangent to each other.

3. The wire according to claim 2, wherein one steel wire conductor of the plurality of steel wire conductors is positioned at a center of the wire.

4. The wire according to claim 3, wherein the steel wire conductors of the plurality of steel wire conductors other than the one steel wire conductor at the center of the wire are arranged around the one steel wire conductor.

5. The wire according to claim 4, wherein the steel wire conductors each have a same diameter as each other and are twisted together.

6. The wire according to claim 4, wherein a diameter of each of the steel wire conductors other than the one steel wire conductor at the center of the wire is different from a diameter of the one steel wire conductor.

7. The wire according to claim 6, wherein the diameter of each of the steel wire conductors other than the one steel wire conductor at the center of the wire is smaller than the diameter of the one steel wire conductor.

8. The wire according to claim 6, wherein the steel wire conductors other than the one steel wire conductor at the center of the wire have a same diameter as each other.

9. The wire according to claim 3, wherein the plurality of steel wire conductors include seven steel wire conductors each having a same diameter as each other, the steel wires of each of the plurality of steel wire conductors have a same diameter.

10. The wire according to claim 9, wherein the diameter of each of the steel wire conductors is 0.25 mm, and a thickness of the copper layer is 3-5 μm.

11. The wire according to claim 1, wherein the wire has a single steel wire conductor located at a center of the wire.

12. The wire according to claim 11, further comprising a plurality of copper wires arranged around the single steel wire conductor, the single steel wire conductor and the copper wires are wrapped in the insulation layer.

13. The wire according to claim 12, wherein the copper wires are twisted onto the single steel wire conductor such that the copper wires are tangent to the single steel wire conductor and any two adjacent copper wires of the copper wires are tangent to each other.

14. The wire according to claim 12, wherein a diameter of the steel wire in the single steel wire conductor is larger than a diameter of each of the copper wires.

15. The wire according to claim 14, wherein the copper wires include eight copper wires having a same diameter as each other.

16. The wire according to claim 15, wherein a diameter of the single steel wire conductor is 0.25 mm, a thickness of the copper layer is 3-5 μm, and the diameter of the copper wires is 0.15 mm.

17. The wire according to claim 1, wherein a thickness of the copper layer is less than 10% of a diameter of the steel wire and greater than 1% of the diameter of the steel wire.

18. The wire according to claim 1, wherein the steel wire is made of a low-carbon steel with a carbon content not exceeding 0.1%.

19. The wire according to claim 1, wherein a strength of the steel wire is not less than 1200 Mpa.

20. A wire, comprising:
a steel wire conductor including a steel wire and a copper layer wrapped around the steel wire;
a plurality of copper wires arranged around the steel wire conductor; and
an insulation layer wrapped around the copper wires.
